(19) United States
(12) Patent Application Publication
(10) Pub. No.: US 2015/0138923 A1
(43) Pub. Date: May 21, 2015

(54) ACOUSTIC CAVITATION IN FLUIDS

(71) Applicant: Frac Innovations, Inc., Dallas, TX (US)

(72) Inventors: Donald Allen Abernathy, New Braunfels, TX (US); James Phillip Wallace, Plano, TX (US)

(21) Appl. No.: 14/091,240

(22) Filed: Nov. 26, 2013

Related U.S. Application Data
(60) Provisional application No. 61/905,591, filed on Nov. 18, 2013.

(51) Int. Cl. G10K 11/18

(52) U.S. Cl. CPC G10K 11/18
USPC 367/137; 367/140

(57) ABSTRACT

in various implementations, a field-deployable system may include an array of two or more acoustic transducers arranged to propagate pressure waves through a hydrocarbon fluid medium. A method of stimulating a hydrocarbon fluid medium may include propagating pressure waves through the hydrocarbon fluid medium. The pressure waves may have an ultrasonic frequency and an amplitude sufficient to induce acoustic cavitation in the hydrocarbon fluid medium. A method of stimulating a solvent fluid medium may include propagating pressure waves through the solvent fluid medium, and inducing acoustic cavitation in the medium via the pressure waves. The acoustic cavitation may form a microjet that impinges a proximate solid surface to substantially remove hydrocarbon residue. An acoustic transducer may be configured to propagate pressure waves through a hydrocarbon fluid medium. The pressure waves may have an ultrasonic frequency and an amplitude sufficient to induce acoustic cavitation in the hydrocarbon fluid medium.

### CROSS-REFERENCE TO RELATED APPLICATION

This application claims priority to U.S. Provisional Patent Application No. 61/905,591, entitled “Acoustic Fracturing and Acoustic Cavitation Systems and Methods,” filed on Nov. 18, 2013, which is hereby incorporated by reference for all purposes.

### TECHNICAL FIELD

The present disclosure relates to apparatus, systems and methods of emitting pressure waves to acoustically cavitate fluids.

### BACKGROUND

Crude is often pumped from a reservoir into a holding tank, or tank battery, where it is stored until it is transported to the refinery. The wait time can range from days to months, depending on the productivity of the well, i.e. tanks storing production from more productive wells may be full within a few days while tanks storing production from poor performing wells may sit for months before being cycled. During this wait time, sedimentation occurs and the more volatile species escape. The heavier chains and contaminants sink to and accumulate at the bottom of the tank, resulting in a layer of nonreactive, viscous mixture of long, entangled hydrocarbon chains, contaminants, solids and water. This mixture is referred to as sludge.

The sludge at the bottom of tanks is problematic for several reasons: It is deemed hazardous by the Environmental Protection Agency (EPA), it is too viscous to flow through pipelines to the refineries, its API gravity is too low (less than 10° API gravity) to be commercially useful, it is sticky and difficult (and costly) to clean, and over time it builds up and dominates the usage of the tank. However, traditional cleaning methods, including manual and semi-automated techniques, require the tank (and hence the well feeding it) to be taken offline for the duration of the process. Further, cleaning a tank requires physically inserting mixing devices and pumps and the use of chemical solvents and cleaners. Also, operators are often required to enter the tank during the cleaning process.

Additionally, oils with values of 30°-40° API gravity are in high demand. This is not only because of their low viscosity but also because of their high volatility and combustibility. Larger hydrocarbons typically form linear chains and polygonal rings. These chains and rings tend to mix with each other in resemblance of knots, further increasing the overall viscosity. As the number of carbon atoms increases, the molecular weight and viscosity of the species also increases while the API gravity decreases.

Volatility is an indication of the ease with which conventional distillation techniques can be used to separate crude into its constituent species. For a known decrease in molecular weight of the hydrocarbons (i.e. increase in API gravity), an unspecified, empirically determined increase in volatility occurs. An increase in volatility means that separation can occur at lower distillation temperatures. That is, lighter hydrocarbons tend to be more volatile and have lower boiling points than their heavier counterparts. Moreover, a change in volatility is often accompanied by a change in combustibility, i.e. the higher the API gravity, the more volatile and the more combustible. Since a large portion of the oil and gas industry is interested in combustion processes that use hydrocarbons as fuel, an increase in combustibility is directly related to economic gain.

### SUMMARY

In various implementations, a field-deployable system for stimulating a hydrocarbon fluid medium may include an array of two or more acoustic transducers arranged to propagate pressure waves through the hydrocarbon fluid medium. The pressure waves may induce acoustic cavitation in the hydrocarbon fluid medium.

Implementations may include one or more of the following features. The field-deployable system may include a structure containing the hydrocarbon fluid medium, and the array may be coupled to the structure. The structure may be a storage tank, a pipeline or a well casing. The array may be coupled to a wall of the structure. The pressure waves may be propagated through the wall of the structure and into the hydrocarbon fluid medium. At least a portion of each of the two or more acoustic transducers may extend through the wall of the structure and into fluid communication with the hydrocarbon fluid medium. At least a portion of each of the two or more acoustic transducers may be disposed within the structure in fluid communication with the hydrocarbon fluid medium. The array may form a flowering arrangement of the two or more acoustic transducers. The field-deployable system may include a power supply having at least one electrochemical capacitor. The field-deployable system may include a controller configured to control: the characteristics of the pressure waves emitted by each of the two or more acoustic transducers, the trigger sequence of the two or more acoustic transducers, or both.

In various implementations, a method of stimulating a hydrocarbon fluid medium may include propagating pressure waves through the hydrocarbon fluid medium. The pressure waves may have an ultrasonic frequency and an amplitude sufficient to induce acoustic cavitation in the hydrocarbon fluid medium.

Implementations may include one or more of the following features. The acoustic cavitation may result in a change in at least one chemical or physical property of the hydrocarbon fluid medium. The acoustic cavitation may result in at least one of the following chemical or physical property changes in the hydrocarbon fluid medium: lower fluid viscosity, lower specific gravity, shortened hydrocarbon chain length, or depolymerization of at least a portion of the hydrocarbon fluid medium. The acoustic cavitation may create a microjet that impinges a proximate solid surface to emulsify a viscous hydrocarbon residue adhered to the proximate solid surface. Emulsifying the viscous hydrocarbon residue may include removing at least a portion of the residue from the proximate solid surface to blend with the hydrocarbon fluid medium.

Propagating pressure waves through the hydrocarbon medium may include: a plurality of acoustic transducers propagating pressure waves directionally inward toward a target zone; a plurality of acoustic transducers propagating pressure waves directionally outward from one another; or a plurality of acoustic transducers propagating pressure waves in generally the same direction.

In various implementations, a method of stimulating a solvent fluid medium may include propagating pressure waves through the solvent fluid medium; and inducing acoustic cavitation in the solvent fluid medium via the pressure waves. The acoustic cavitation may form a microjet that impinges a proximate solid surface to substantially remove hydrocarbon residue from the proximate solid surface.

Implementations may include one or more of the following features. The proximate solid surface may form part of an oilfield tool or a piece of oilfield equipment. Substantially removing hydrocarbon residue may clean the proximate solid surface of the oilfield tool or the piece of oilfield equipment. Substantially removing hydrocarbon residue from the proximate solid surface may include emulsifying the hydrocarbon residue.

In various implementations, an acoustic transducer may be configured to propagate pressure waves through a hydrocarbon fluid medium. The pressure waves may have an ultrasonic frequency and an amplitude sufficient to induce acoustic cavitation in the hydrocarbon fluid medium.

Implementations may include one or more of the following features. The acoustic transducer may include a wave propagation device that amplifies and focuses the pressure waves. The wave propagation device may include a side profile that follows a mathematical formula and a radially symmetric cross section. The side profile may have a cascaded mirror image structure. The side profile may have a cascaded repeated structure. The wave propagation device may include a hollow subsection, a solid subsection, or both. A tip subsection comprises a concave, a flat or a convex distal surface. The acoustic transducer may include a tuning mass. The acoustic transducer may include a ceramic material, a crystal material or an organic material.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1A illustrates a side view of an implementation of a sonofracing apparatus.

FIG. 1B illustrates a top view of the sonofracing apparatus of FIG. 1A disposed within a stimulating well proximate to a downhole rock formation.

FIGS. 2A through 2D illustrate acoustic shockwave formation.

FIG. 3 illustrates a side view of an implementation of a sonofracing system deployed within a single stimulating well.

FIG. 4A illustrates a side view of an implementation of a sonofracing system deployed within multiple stimulating wells.

FIG. 4B illustrates a top view of an implementation of a sonofracing system deployed within a single stimulating well.

FIGS. 4C through 4E illustrate top views of various implementations of sonofracing systems deployed within multiple stimulating wells.

FIGS. 5A and 5B illustrate implementations of a sonofracing system modified to induce a low frequency carrier or shear wave with a series of ultrasonic shockwaves embedded therein.

FIG. 6A illustrates an implementation of a triggering sequence of a sonofracing system.

FIG. 6B illustrates a lower frequency carrier wave resulting from the triggering sequence of FIG. 6A.

FIG. 6C illustrates the superposition of the carrier wave of FIG. 6B with a stream of shockwaves embedded thereon.

FIG. 7A illustrates a side view of an implementation of a sonofracing apparatus.

FIG. 7B illustrates a side view of an implementation of a sonofracing system deployed within a single stimulating well.

FIG. 8 illustrates cavity growth and implosive collapse characteristics of acoustic cavitation in fluids.

FIG. 9 illustrates a side view of an implementation of an acoustic assembly of a fluid stimulating apparatus.

FIGS. 10A through 10C illustrate various implementations of a fluid stimulating apparatus with an elongated ultrasonic wave propagation device.

FIG. 11 illustrates an implementation of a fluid stimulation system coupled to an exterior surface of tank containing a fluid medium.

FIG. 12A illustrates an implementation of a fluid stimulation system with roof-mounted fluid stimulation apparatuses extending at least partially into a tank containing a fluid medium.

FIG. 12B illustrates an implementation of a fluid stimulation system with side-mounted fluid stimulation apparatuses extending at least partially into a tank containing a fluid medium.

FIGS. 13A and 13B illustrate various implementations of a fluid stimulation system with a flowering arrangement of fluid stimulation apparatuses.

FIG. 13C illustrates an implementation of a mobile platform deploying a fluid stimulation system into a tank containing a fluid medium.

FIG. 14 illustrates an implementation of pipeline for transporting hydrocarbons.

FIG. 15 illustrates an implementation of a fluid stimulation system coupled to a pipeline.

FIG. 16 illustrates an implementation of a fluid stimulation system coupled to a pipeline and being used to detect the ultrasonic footprint of a pipeline leak.

FIGS. 17A through 17D illustrate acoustic cavitation forming microjets resulting from the formation and collapse of microscopic bubbles near a proximate solid surface.

FIGS. 18A and 18B illustrate various implementations of ultrasonic cleaning systems.

### DETAILED DESCRIPTION

Embodiments of the present disclosure generally provide apparatuses, systems and methods for stimulating downhole rock formations and stimulating fluids. In various embodiments, a shockwave sonic fracturing system may comprise one or more arrays of sonofracing apparatuses configured to generate and transmit pressure waves into a formation to deform the formation. In various embodiments, a sonofracing apparatus may generally comprise an acoustic assembly, a mass, and a transmission component. In various embodiments, a fluid stimulation system may generally comprise an array of two or more fluid stimulation apparatuses configured to stimulate fluids in a storage tank, pipeline or downhole environment.

As used herein, the term stimulation may be understood to have various meanings depending upon the context in which it is used. In the context of stimulating downhole rock formations, stimulation may generally refer to the use of acoustic pressure waves to alter the permeability of the downhole rock formation to enhance hydrocarbon recovery therefrom. In the context of stimulating fluids, stimulation may generally refer to the use of acoustic pressure waves to alter the chemical and/or physical properties of a fluid, such as a hydrocarbon or a solvent. With respect to hydrocarbons, stimulation may alter, without limitation, the viscosity, specific gravity, and thereby API gravity of those hydrocarbons. As used herein, the term “hydrocarbon” broadly refers to any compound, such as crude oil, petroleum products, gases (natural gas, propane, etc.), sludge, residue, etc. that may be recovered, treated, or otherwise encountered in energy industry operations. As used herein, the term “solvent” broadly refers to any substance capable of dissolving a chemically different substance. These are general meanings, not necessarily rigid definitions; accordingly, the terms “stimulation” (and derivatives thereof, such as “stimulate” or “stimulating”), “hydrocarbon(s)” and “solvent(s)” should be read in light of the particular context in which it is presently used herein.

### Stimulating Formations—Shockwave Sonofracturing

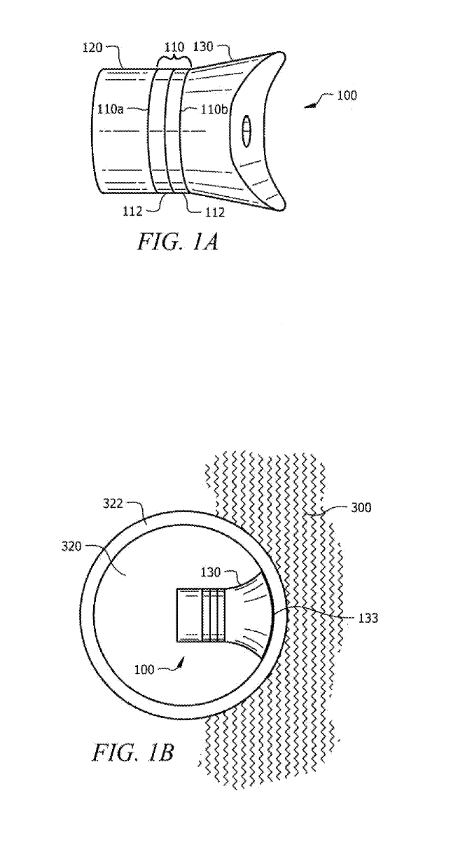

FIGS. 1A and 1B illustrate representative embodiments of shockwave sonic fracturing apparatus (“sonofracing apparatus”) 100, and parts thereof. It should be understood that the components of sonofracing apparatus 100, and parts thereof shown in FIGS. 1A and 1B are for illustrative purposes only, and that any other suitable components or subcomponents may be used in conjunction with or in lieu of the components comprising sonofracing apparatus 100 described herein.

Referring now to FIG. 1A, sonofracing apparatus 100 may generally comprise acoustic assembly 110, mass 120, and transmission component 130. Acoustic assembly 110 may comprise any suitable device capable of emitting pressure waves. In various embodiments, acoustic assembly 110 comprises one or more transducers 112 configured to expand, contract or otherwise physically deform upon actuation, thereby emitting pressure waves. In an embodiment, transducer 112 may comprise a piezoelectric transducer, but one having ordinary skill in the art will recognize that any number of suitable transducers is envisioned within the scope of this disclosure. Transducer 112 may be of any suitable shape, and in some embodiments, may be disk-shaped or ring-shaped.

In various embodiments, acoustic assembly 110 may comprise a stack of transducers 112. In an embodiment, each transducer 112 may be configured to actuate simultaneously (i.e., wired in parallel), producing impulses in both directions parallel to the expansion/contraction of transducers 112—i.e., along the axis of the stack. Simultaneous impulses in a given direction would be in-phase and therefore additive, producing a stronger impulse. Additionally, in various embodiments, each transducer 112 may be configured to operate from a fully compressed (or expanded) position rather than from an equilibrium position, effectively doubling the length of its expansion stroke (or compression stroke) and increasing impulse power output.

Sonofracing apparatus 100 may further comprise a mass 120. In an embodiment, mass 120 may be coupled with a first end 110a of acoustic assembly 110, and may be in general axial alignment therewith. Mass 120 may be comprised of any suitable material, and may be tuned to adjust the properties of waves emitted from acoustic assembly 110. One having ordinary skill in the art will recognize proper tuning characteristics for a given application. Mass 120 may be further shaped to direct pressure waves emitted from acoustic assembly 110 in a predetermined direction. In an embodiment, mass 120 may comprise a flat surface where it couples with the first end 110a of acoustic assembly 110, the flat surface configured to reflect pressure waves back along the axis of acoustic assembly 110. The reflected impulse may be almost perfectly in phase with the other impulse, thereby creating an additive effect that strengthens the pulse emitted from a second end 110b of acoustic assembly 110. In another embodiment, mass 120 may be further shaped to direct pressure waves emitted from acoustic assembly 110 in non-axial directions. Although losses in impulse strength may occur at the boundary of mass 120, the energy density of the reflected impulse may be maximized through appropriate acoustic (mass) mismatching. High dielectric, high strain lead zirconate titanate (PZT) ceramics can provide a high energy density impulse and as such are appropriate for this application. Additionally, sonofracing apparatus 100 may comprise crystal materials or organic materials.

Sonofracing apparatus 100 may further comprise a transmission component 130. Transmission component 130 may comprise any suitable component capable of transmitting pressure waves emitted from acoustic assembly 110 into a nearby medium. In an embodiment, transmission component 130 may couple with the second end 110b of acoustic assembly 100 and project axially therefrom. In an embodiment, transmission component 130 may be configured to fit flush with a surface associated with a medium to be stimulated.

In various embodiments, sonofracing apparatus 100 may be in communication with a power source and/or controller 140. Power source/controller 140 may provide power (electric, hydraulic, etc. depending on the construction of acoustic assembly 110) to one or more sonofracing apparatuses 100, and may control the characteristics of the pressure waves emitted by each acoustic assembly 110, the trigger sequence of each acoustic assembly 110, or both. In an embodiment, power source/controller 140 may comprise at least one electrochemical capacitor.

Referring now to FIG. 1B, sonofracing apparatus 100 may be configured to fit within a stimulating well 320 proximate to a downhole rock formation (“formation”) 300. In various embodiments, sonofracing apparatus 100 may be positioned in a substantially radial orientation within stimulating well 320, which may comprise a wellbore lined with well casing 322. In an embodiment, transmission component 130 may have a convex distal surface 133 suitable for coupling with a curved inner surface of well casing 322.

In operation, acoustic assembly 110 may operate to emit pressure waves. For embodiments comprising a stack of transducers 112, each transducer 112 may substantially simultaneously expand or contract to create pressure waves along the axis of sonofracing apparatus 100. Mass 120 (if equipped) may reflect some of these pressure waves back toward transmission member 130, and transmission member 130 may transmit the original and reflected waves through well casing 322 and into formation 300. Mass 120 may also function to tune the frequency and other properties of pressure waves emitted from acoustic assembly 110.

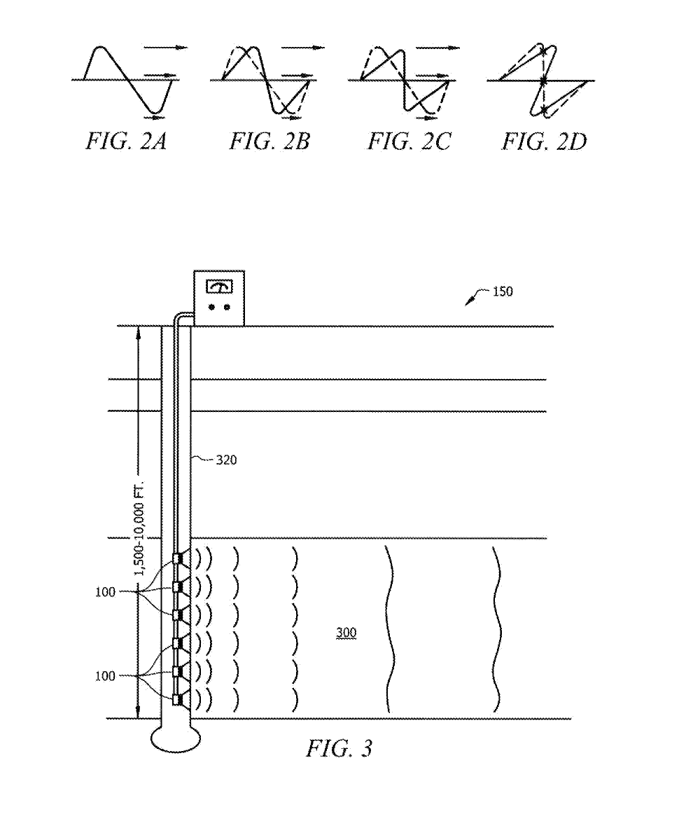

FIGS. 2A-2D illustrate typical shockwave formation. As pressure waves propagate, they may form shockwaves under appropriate conditions. FIG. 2A depicts an initial waveform, and the length of the arrows indicates the local phase velocity. Referring to FIG. 2B, the solid line depicts the waveform after a short amount of time has passed, and the dashed line depicts the initial waveform to illustrate the subsequent distortion. FIG. 2C illustrates shockwave formation where the slope of the waveform becomes infinite. FIG. 2D depicts a multi-valued waveform, which is nonphysical because acoustic waves cannot break like ocean waves do.

If an acoustic wave is of sufficiently large amplitude, its speed through a medium is no longer constant but rather becomes dependent upon the local compression of the medium, i.e. is nonlinear. The speed increases with increasing pressure so the peak of a wave propagates faster than does the trough, resulting in the steepening of the peaks. However, because sound waves are compressional they are 1-dimensional. As the peaks steepen toward infinite slope, they do not behave as their 2-dimensional counterparts (water waves) do and break but rather form a shockwave. Shockwaves carry significant amounts of energy, harnessing the otherwise diffuse energy of the wave to just a single point.

All sound waves are capable of producing shockwaves but most rarely do. Energy losses due to acoustic impedance combat shock formation. These losses are additive and are a function of distance traveled. The shock formation distance, the point at which the waveform attains infinite slope, is

$$\overline{x} = \frac{{ρ}_{∞} {c}^{3}}{2 πβ {P}_{p} υ} ,$$

where ρ_{∞} is the ambient density, c is the speed of sound, Pₚ is the peak pressure, υ is the frequency, and β is a material-dependent quantity called the coefficient of the nonlinearity. The shock formation distance is directly proportional to the density of the medium, which in turn is proportional to the inverse of the square of the speed. The distance is proportional to the speed, so the faster the wave travels through a medium, the farther it has to go before it produces a shockwave. Also, the higher the peak pressure and the higher the frequency, the shorter the distance. Each sonofracing apparatus 100 may be configured to control the distance at which pressure waves form shockwaves, providing for the ability to focus shockwaves into a desired location in a medium. One having ordinary skill in the art will recognize suitable wave characteristics required to induce shockwaves at a desired distance into mediums of various compositions.

Suitable pressure wave properties will be selected for a given application. In various embodiments, pressure waves are emitted in the ultrasonic frequency range. In downhole applications, the target shockwave formation distance corresponding to a target zone may be up to 16,000 feet (1-5 km). While most audible sound waves have to travel so far that they lose the energy required for the nonlinearity to persist, high frequency waves may produce shockwaves more effectively. For example, ultrasonic frequencies can produce a shockwave in as little as 10 cm. One having ordinary skill in the art will recognize other suitable frequencies for a given application.

FIGS. 3-6C illustrate representative embodiments of a shockwave sonic fracturing system (“sonofracing system”) 150, and parts thereof. It should be understood that the components of sonofracing system 150 and parts thereof shown in FIGS. 3-6C are for illustrative purposes only, and that any other suitable components or subcomponents may be used in conjunction with or in lieu of the components comprising sonofracing system 150 described herein.

Referring now to FIG. 3, sonofracing system 150 may comprise one or more arrays of sonofracing apparatuses 100 configured to generate and transmit pressure waves into formation 300 to deform formation 300. In an embodiment, deforming formation 300 may comprise acoustic fracturing of formation 300. Sonofracing apparatuses 100 may periodically induce shockwaves in a hydrocarbon-containing formation 300 to stimulate the rock formation itself.

In various embodiments, sonofracing system 150 may comprise an array of radially oriented sonofracing apparatuses 100 disposed axially within a stimulating well 320 and configured to emit pressure waves toward a target zone 310 (not shown) of formation 300. As pressure waves propagate through formation 300, they may build to form shockwaves. To enhance the power of the shockwaves generated by system 150, several factors need to be considered: number and size of sonofracing apparatuses 100, properties of masses 120 and transmission members 130, any mechanical coupling, supplied power, duty cycle, etc. These factors do not behave independently and consequently, careful analysis of the stimulating well 320 and formation 300 conditions dictate the design. In contrast to medical lithotripsy, where lithotripters are placed along a parabolic surface that focuses the waves to a well-defined point, the downhole sonofracing apparatuses 100 may be mechanically coupled to the convex inner wall of well casing 322 that lines stimulating well 320, diffusing the waves emitted therefrom. Finally, the number of sonofracing apparatuses 100 in a stimulating well 320 is a function of the fracture gradient of the formation 300 and the required shockwave power, and will be determined on a field-to-field basis.

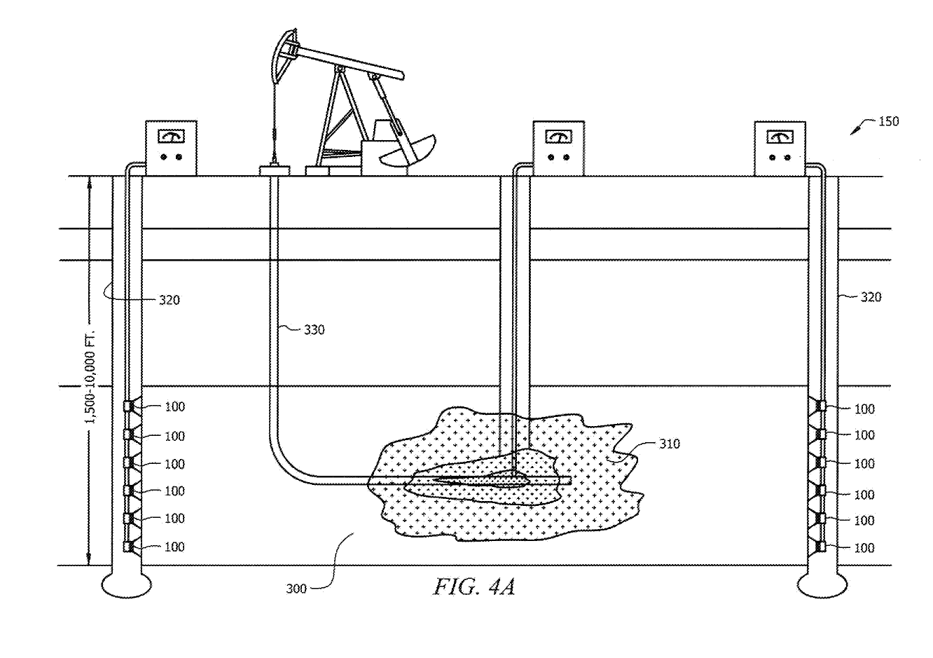

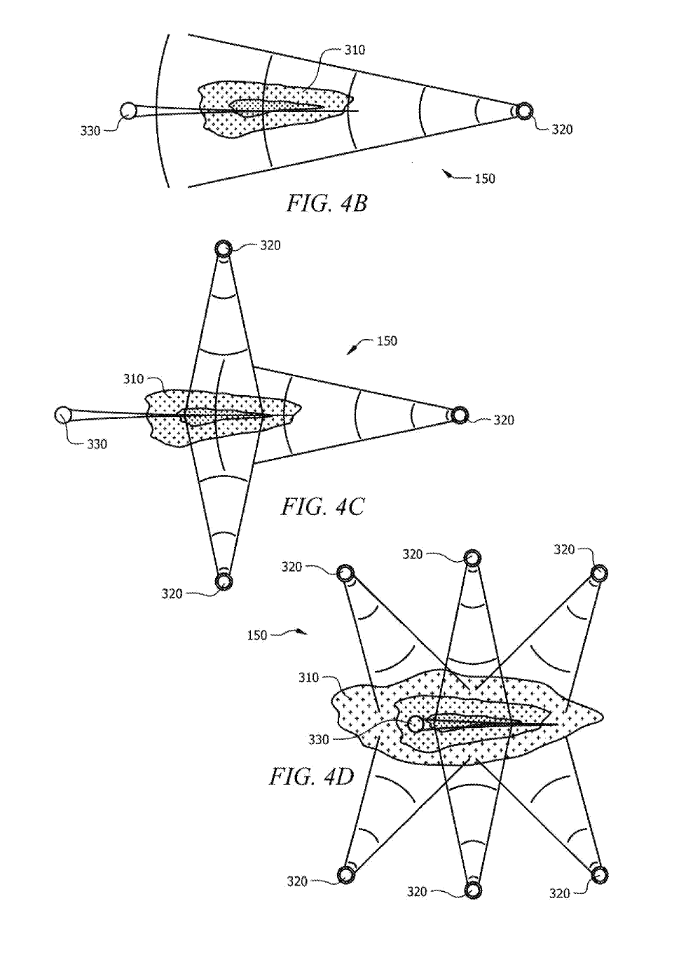

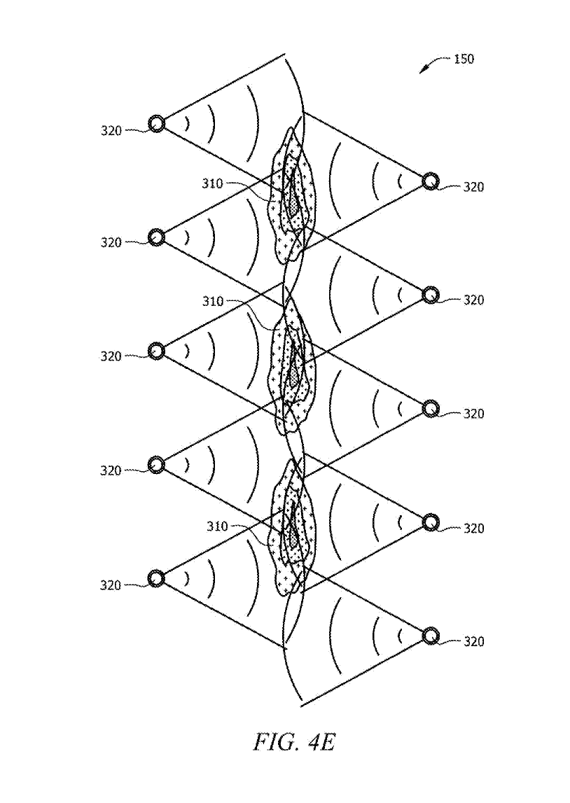

Referring now to FIG. 4A, sonofracing system 150 may comprise one or more arrays of sonofracing apparatuses 100 configured for deployment in multiple stimulating wells 320. To facilitate the high pressures needed downhole, each array may be directed toward a target zone 310 accessible by a producing well 330. Target zone 310 may comprise any portion of formation 300 to be stimulated, and in an embodiment, may comprise a zone where one or more poor performing lateral well 330 exists. While almost any configuration may work, the process typically starts by selecting at least two conventionally drilled vertical wells within the proximity of a target zone 310. Bridge plugs (not shown) may be set just below formation 300 to isolate lower perforated intervals. The best choice of configuration may be dependent upon the geology of formation 300 and the topology and condition of wells 320, 330.

Because the pulses may be radially diffuse, the exact location of each stimulating well 320 in reference to the others may not be as important as the number of stimulating wells 320. Depending upon the nature of formation 300 and the configuration of the predrilled stimulating wells 320 in the oilfield, the number and position of stimulating wells 320 will be established. However, as a general rule, the more stimulating wells 320, the larger the shockwave. Also, the more overlap of the individual shockwaves, the larger the focal zone of stimulation (sound waves are not coherent and tend to spread so instead of a focal point they have a focal zone). In other words, large focal zones allow for longer or more numerous producing wells in a given field.

The exact configuration of an outfitted oilfield cannot be decided generically; each field is unique and needs to be treated as such for maximum efficiency and hydrocarbon recovery. Some formations will be sufficiently stimulated with a single stimulating well 320 while others may benefit from stimulation by five or six stimulating wells 320. Sprawling oilfields may be stimulated with parallel and staggered arrays of stimulating wells 320. The distance between stimulating wells 320 and producing wells 330 is one of the more easily managed variables to be considered due to the tunability of the shockwave formation distance. With the appropriate array deployed, downhole pressures of 100-200 MPa should be easily attainable at the focal zone of stimulation. Economics play an important role in the configuration of stimulating wells in an oilfield; there is a point of diminishing returns and any additional well after that is no longer beneficial. As mentioned above, careful geographic analysis of the oilfield may be performed prior to any retrofitting.

FIGS. 4B-4E depict top schematic views of illustrative embodiments of sonofracing system 150. Referring to FIG. 4B, sonofracing system 150 may comprise an array of sonofracing devices 100 deployed within a single stimulating well 320 directing acoustic pressure waves toward a target zone 310 accessible by a producing well 330. Referring to FIG. 4C, sonofracing system 150 may comprise one or more sonofracing devices 100 deployed in each of multiple stimulating wells 320, such as three stimulating wells 320, substantially surrounding and directing acoustic pressure waves toward a common target zone 310 accessible by a producing well 330. Referring to FIG. 4D, sonofracing system 150 may comprise one or more sonofracing devices 100 deployed in each of multiple stimulating wells 320, such as six stimulating wells 320, substantially surrounding and directing acoustic pressure waves toward various areas of a target zone 310 accessible by a producing well 330. Referring to FIG. 4E, sonofracing system 150 may comprise one or more sonofracing devices 100 deployed in each of multiple stimulating wells 320 directing acoustic pressure waves toward multiple target zones 310 accessible by one or more producing wells (not shown). In various embodiments, pressure waves emitted from each stimulating well 320 may or may not overlap with pressure waves emitted from other stimulating wells 320.

In various embodiments, the triggering sequence of sonofracing apparatuses 100 in sonofracing system 150 may be controlled. In an embodiment, triggering the plurality of sonofracing apparatuses 100 within each well 320 may comprise continuously emitting pressure waves having a given pressure and a given duration at a given frequency. In another embodiment, the given pressure may exceed the fracture gradient of at least a portion of downhole formation 300. For enhanced stimulation, pressure waves emitted from each stimulating well 320 should form shockwaves at the focal zone at approximately the same time (or at approximately an appropriate time along an induced seismic wave such that the waves are in phase). Seismic waves (and all waves, for that matter) are linearly additive. If the waves are of similar shape and are in phase, they will undergo constructive addition while if they are dissimilarly shaped and/or out of phase, they will experience partial or even complete cancelation. Therefore, for maximum stimulation to occur, the shockwaves should form in the vicinity of target zone 310 and all incident shockwaves should add constructively. Because formation 300 is likely nonuniform, the frequency and pressure from each sonofracing apparatus 100 may have to be specifically tuned. The tuning process may comprise monitoring real-time ultrasonic analysis of the formation 300 as it is being stimulated. Sonofracing apparatuses 100 may sweep through a predetermined, formation-dependent frequency range and coarse (low spatial and temporal resolution) data may be collected. As peak conditions are neared, the sweep rate may be slowed and the resolution of the data increased. These peak conditions are evidenced by a frequency-dependent increase in seismic activity; below or above this frequency or frequency range, the microseismic activity decreases. These real-time measurements may provide accurate information about the seismic events as they occur. This data may be taken into account and the trigger sequence adjusted as necessary.

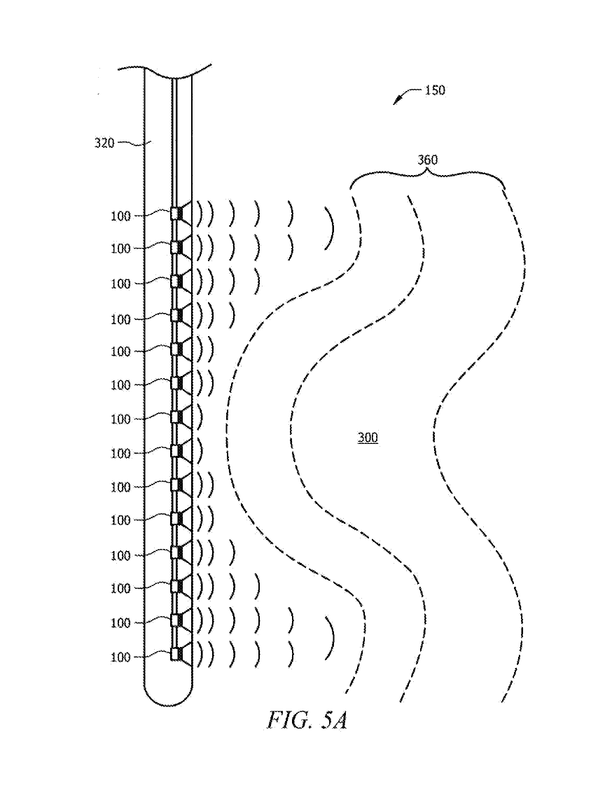

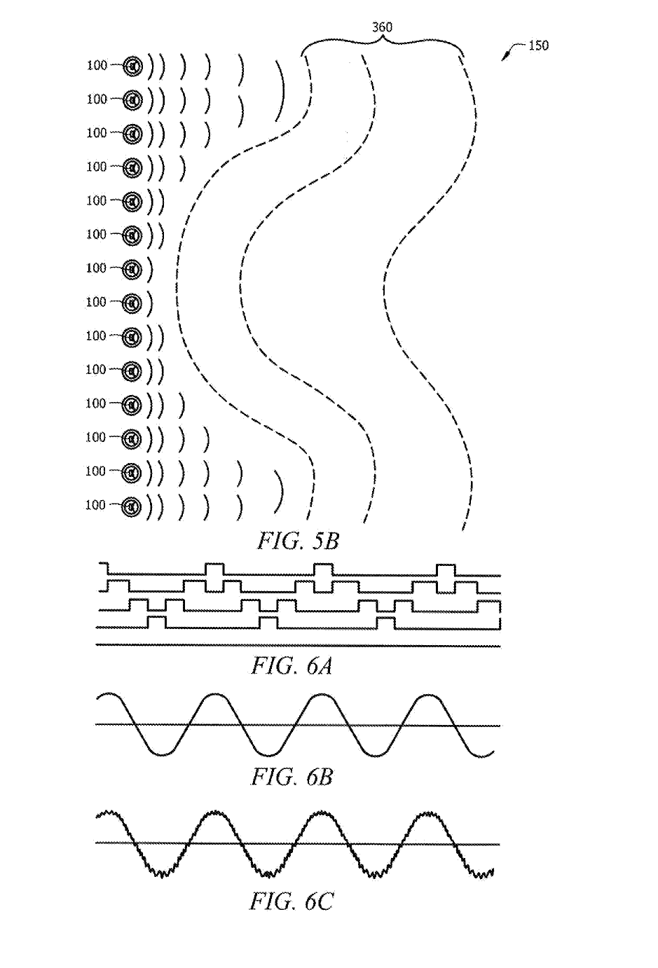

Referring now to FIGS. 5A and 5B, in various embodiments, sonofracing system 150 may be modified to induce a low frequency carrier wave 360 (shear wave) having embedded within it a series of ultrasonic shockwaves. Common, naturally occurring seismic events may stimulate oil production in nearby fields. In some capacity, hydraulic fracturing is the reverse engineering of a seismic event or the pressures associated with a seismic event with the goal of enhancing oil recovery. High pressure acoustic waves can be used to accomplish the same goal.

Waves associated with seismic events either travel though the body of the earth or along the surface. Body waves have two forms: Primary waves (P-waves) that are compressional and travel at the speed of sound through all media (solid, liquid, gas) and secondary waves (S-waves) that are transverse, travel slower than P-waves, and travel only through solids (shearing does not occur in liquids or gases). It is these body waves that are measured with seismographs all around the world and allow scientists to pinpoint the exact location of a seismic event. Surface waves are transverse, slow, and are responsible for most surface destruction. Surprisingly, a typical amplitude for a seismic wave is 10⁻¹⁰-10⁻¹ m. These small displacements are responsible for an earthquake, and hence the associated damage.

Seismic events occur in the subsonic range (<1 Hz) and microseismic events in the low frequency audible range (10-100 Hz). However, it is unlikely that these low frequency excitations are the cause of the rock breakage but rather the effect of such rock breakage. The breakage itself is more likely due to the enormous pressures that are released when an event occurs. A seismic event pushes and pulls on a rock formation, opening and closing pores and fissures as it propagates. These new, temporary crevices are conduits for the subsurface pressures to escape. The initial release can be of high enough force that the results are catastrophic. However, statistically speaking, the forces generated are rarely more than negligible.

In various embodiments, an array of sonofracing apparatuses 100 is deployed in one or more stimulating wells 320 as before, and each sonofracing apparatus 100 is sequentially triggered such that a lower frequency carrier wave travels through formation 300. The goal here is to induce low frequency shear waves 360 through the formation 300 by triggering sequential shockwaves. This process is analogous to frequency modulation in radios, having the ultrasonic footprint from the transducers embedded in a lower frequency carrier wave.

In other words, a shockwave is generated and propagated through the formation, another is generated and propagated, and another. The shockwaves form at the focal zone as before, but their sequence simultaneously induces a carrier wave 360 whose frequency follows the triggering sequence. If a single shockwave at the focal zone is desired, the simple parallel triggering of all sonofracing apparatuses 100 will suffice. If, however, a broader, induced shear wave 360 is desired, the number and/or power of the sonofracing apparatuses 100 will increase toward the minimum data points required to define a curve. A square wave may be defined with 2 points (high and low), a triangle wave may be defined with 3 points (high, mid, and low), and a sine wave may be defined with 5 or 7 points. If a coarse sine wave can be defined with 7 data points, then either the power of the transducers or the number of arrays may be increased by 7 times.

Referring now to FIGS. 6A-6C, a modulated sonofracing example is provided for illustrative purposes. FIG. 6A graphically depicts a triggering sequence of sonofracing system 150 in which each of ten sonofracing apparatuses 100 (28 kHz) triggers a 100 μs pulse every second, each staggered by a 100 μs pulse width. FIG. 6B depicts the resulting lower frequency carrier wave. FIG. 6C depicts the superposition of the 1 Hz envelope wave with a 28 kHz data stream (or stream of building shockwaves) embedded on it that will be produced. The carrier wave will travel almost unencumbered through formation 300, allowing the ultrasonic portion to develop a shockwave as it travels.

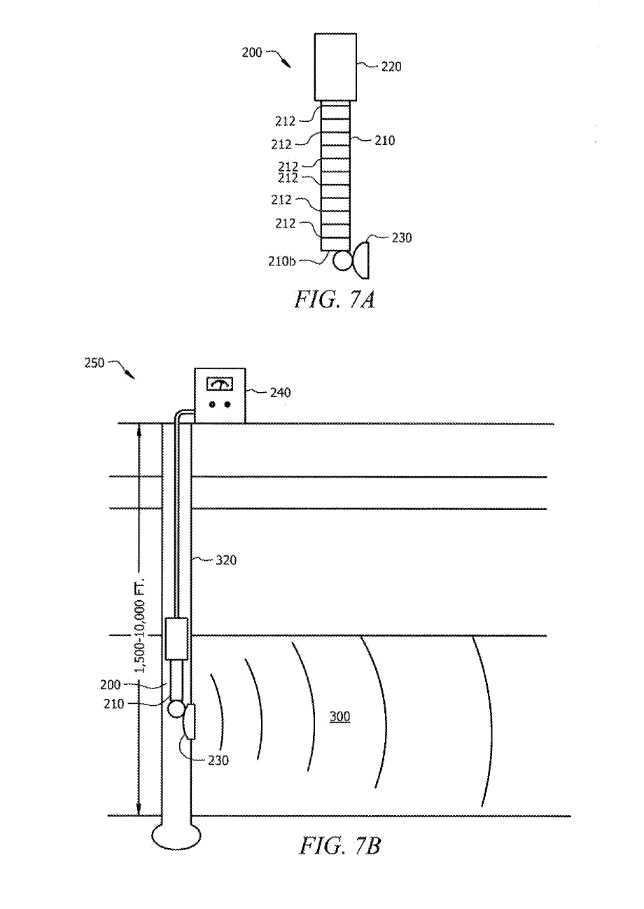

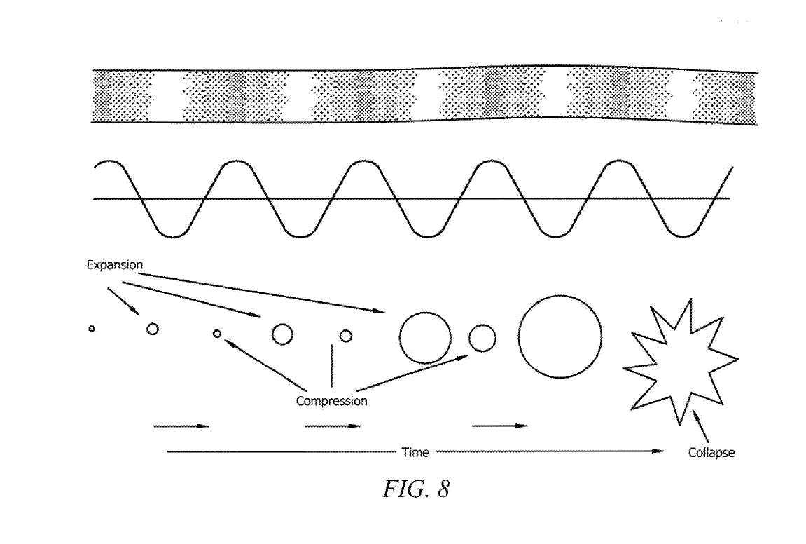

FIGS. 7A and 7B illustrate representative embodiments of shockwave sonic fracturing (“sonofracing”) apparatus 200 and system 250, and parts thereof. It should be understood that the components of sonofracing apparatus 200 and system 250, and parts thereof shown in FIGS. 7A and 7B are for illustrative purposes only, and that any other suitable components or subcomponents may be used in conjunction with or in lieu of the components comprising sonofracing apparatus 200 and system 250 described herein.

Referring now to FIG. 7A, sonofracing apparatus 200 may comprise generally similar components as sonofracing apparatus 100. For example, sonofracing apparatus 200 may comprise acoustic assembly 210, mass 220, and transmission component 230, each having the same general characteristics as its respective counterpart 110, 120 and 130, respectively, in sonofracing apparatus 100. Similarly, sonofracing apparatus 200 may be in communication with a power source and/or controller 240 having similar characteristics as power source/controller 140. However, sonofracing apparatus 200 may differ somewhat in structure and operation.

Referring to FIG. 7B, in various embodiments, sonofracing apparatus 200 may be configured to operate in an axial orientation within a well. Because most wells are long and narrow, an axially oriented configuration may provide for sonofracing apparatus 200 to be longer than embodiments of sonofracing apparatus 100 configured for radial orientation within a well. Referring back to FIG. 7A, embodiments with an axially oriented configuration may comprise a longer acoustic assembly 210 as compared to the acoustic assembly 110 of sonofracing apparatus 100. As such, acoustic assembly 210 may be more powerful than the shorter embodiment of acoustic assembly 110. In an embodiment, acoustic assembly 210 may comprise larger transducers 212. In another embodiment, acoustic assembly 210 may comprise a larger stack of transducers 212. In some embodiments, acoustic assembly 210 may comprise a stack of tens or even hundreds of transducers 212 configured to trigger substantially simultaneously to create very strong pressure waves.

Sonofracing apparatus 200 may comprise a transmission component 230 configured to transmit and direct pressure waves emitted from acoustic assembly 210 in nonaxial directions. In an embodiment, transmission component 230 may be fixedly coupled with a second end 210b of acoustic assembly 210 and shaped to direct emitted pressure waves in a predetermined direction. In another embodiment, transmission component 230 may be moveably coupled with a second end 210b of acoustic assembly 210 via any suitable coupler, such as a ball joint. Referring to FIG. 7B, in an embodiment, transmission component 230 may be positioned at an angle, such as approximately a right angle, relative to acoustic assembly 210, providing for emitted pressure waves from acoustic assembly 210 to be directed radially outwardly into formation 300.

Still referring to FIG. 7B, sonofracing system 250 may comprise one or more sonofracing apparatuses 200 configured to emit and transmit pressure waves into formation 300 to deform formation 300. In an embodiment, deforming formation 300 may comprise acoustic fracturing of formation 300. Similar to hydraulic fracturing, in which water pressure is applied downhole to create microfractures in surrounding rock, sonofracing system 250 may generate pressure waves configured to induce a periodic seismic event resulting in a hammer effect approximately at the interface between a stimulating well 320 in which the one or more sonofracing apparatuses 200 operate and the downhole formation 300. In an embodiment, the hammer effect occurs approximately at well casing 322 lining the stimulating well 320. In another embodiment, the frequency of the induced periodic seismic events may exceed 0.01 Hz.

If applying ˜10 MPa of water pressure downhole (˜120 MPa aboveground) creates microfractures in the rock formation, applying that same amount of acoustic pressure should do the same. In other words, sonofracturing with sonofracing system 250 may replace existing hydraulic fracturing technologies. In order to affect change downhole, the output power (acoustic pressure) needs to be significantly higher and mass 220 needs to be tuned specifically to provide rigidity and support against formation 300. If tuned properly, sonofracing apparatus 200 may not only produce roughly 10 times the pressure downhole, it may also be associated with considerably less economic and environmental impact as compared to hydraulic fracturing, i.e. no chemical additives, fracturing fluid or proppants will be required and no hazardous waste-water will be produced. Forces on the order of 10 kN at a repetition rate of 1 Hz can be achieved, resulting in stresses on the order of 100 MPa with lifetimes of 100 μs.

In various embodiments, sonofracing system 250 may be a semi-permanent fixture in a stimulating well 320. Accordingly, the impact transduction (sonofracturing) can be applied on a semi-continuous basis (continuously pulsed). Triggering a 100 MPa pulse of 100 μs at 1 Hz for the duration of the lifetime of a well may be sufficient to reach upwards of 85-90% recovery. That said, other triggering sequences are just as valid. Pulse width, duty cycle, repetition rate, etc. can all be altered according to the requirements and constraints of the stimulated region of the formation 300. Also, for embodiments in which more than one stimulating well 320 is used, more than one triggering sequence may be used.

In various embodiments, sonofracing system 250 may be deployed in the field in a similar manner as sonofracing system 150. In various embodiments, sonofracing system 250 may comprise one or more sonofracing apparatuses 200 disposed within one or more stimulating wells 320 with their respective transmission components 230 oriented toward a target zone 310 in formation 300 accessible by a producing well 330. Similarly, in various embodiments, sonofracing system 250 may comprise one or more sonofracing apparatuses 200 disposed within multiple stimulating wells 320 with their respective transmission components 230 having overlapping orientations toward different areas of a large target zone 310 or towards multiple target zones 310. In an embodiment, sonofracing system 250 may comprise a single sonofracing apparatus 200 deployed in a given stimulating well 320. In another embodiment, sonofracing system 250 may comprise an axial array of sonofracing apparatuses 200 deployed in a given stimulating well 320.

### Stimulating Fluids—Induced Acoustic Cavitation

FIG. 8 illustrates cavity growth and implosive collapse characteristics of acoustic cavitation in a fluid.

Ultrasonic irradiation of liquids produces a resonant effect called acoustic cavitation. Unlike in hydrodynamic cavitation, liquid flow is not required in acoustic cavitation because the acoustic waves themselves (which are pressure waves) produce the necessary pressure differentials. In the negative pressure half-cycle of the wave, if the acoustic wave is intense enough to overcome the tensile strength of the liquid (which is generally small), it can pull the liquid apart and form a bubble. The positive half-cycle then compresses the bubble. Then the next negative phase re-expands it. The bubble oscillates in this way at the irradiation frequency.

However, not only does the cavity oscillate, it also grows through a nonlinear mechanism known as rectified diffusion. The surface area of the interface in the expansion phase is just larger than in the compression phase; the growth phase is slightly faster than the collapse phase. So the bubble oscillates and grows over the course of many periods. At some point in its lifetime, the bubble reaches its frequency-dependent resonant size. Once in resonance, it can efficiently absorb acoustic energy and grow quickly in a single harmonic period. Once it has grown beyond its resonant radius, however, it is no longer in resonance with the sound field, i.e. it cannot efficiently absorb acoustic energy. This results in an almost instantaneous collapse, creating a hot spot and shockwave in its stead.

Acoustic cavitation is a thermodynamic process that occurs as a function of a polytropic pressure differential in an otherwise isotropic liquid. The governing relation is PV^{γ}=C, where P is pressure, V is specific volume, γ is the polytropic index (generally empirically determined), and C is a constant.

If a few assumptions are made (neglecting viscous attenuation and surface tension, for example), the radius, r of a single bubble in water can be calculated according to Minnaert's formula,

$$r = \frac{1}{2 πυ} {( \frac{3 γ {P}_{∞}}{ρ} )}^{1 / 2} ,$$

where υ is the applied ultrasonic frequency. In standard conditions (P^{∞}=100 kPa, ρ=1000 kg/m³), this relation reduces to roughly

$$r \approx \frac{3.26}{υ} .$$

If the ultrasonic frequency is 28 kHz, the resonant bubble has a radius of 116 μm. Although this is just an approximation and the result of a few somewhat unrealistic assumptions, it agrees with experimental studies quite well.

These acoustic cavities have been experimentally proven to be under exactly the extreme physical conditions predicted by Rayleigh, including temperatures of ˜5000 K, pressures of ˜2000 atm, and heating and cooling rates of ˜10⁵ K/s. This process, and hence these conditions and the environments they produce, has a lifetime of ˜100 ns to ˜10 μs but occurs continuously throughout the fluid at a rate proportional to the ultrasonic frequency (15 kHz<υ<100 kHz). At any given time, thousands of microbubbles are in existence, producing thousands of microenvironments in which sonochemistry (sound-induced or influenced chemical reactions) occurs. These sonochemical reactions include, but are not limited to, lysis, the breaking apart of cells, and free radical formation.

When ultrasonic waves travel through water, their phase velocities are on the order of ˜1500 m/s and their wavelengths range from ˜15 to ˜100 mm. The wavelengths of these acoustic waves are important in that they dictate what the waves can and cannot interact with. Acoustic waves of a certain size (wavelength) affect objects and chemical bonds of a similar size. More to the point, acoustic waves that are 15 mm (1.5×10-2 m) or bigger do not directly interact with molecules (˜4×10-10 m). Sonochemistry is not a direct result of the applied acoustic field but rather of the acoustic cavitation that the field produces. As can be seen above, acoustic cavitation is essentially a means of harnessing and concentrating the otherwise diffuse energy of sound.

The hydrodynamic cavitation of hydrocarbons produces results similar to those expected from very high temperature pyrolysis, namely H₂, CH₄, and smaller alkenes, but at much lower working temperatures and reaction times. Interestingly, the typical size of acoustic cavities (5-100 μm) coincides exactly with those of hydrocarbon molecules. Acoustic cavitation, as it turns out, is even more efficient and with significantly fewer moving (and degradable) parts.

It has been demonstrated that irradiating extra heavy sludge has resulted in oil upgradation through what is known by chemists as sonolysis. We have determined that irradiating 100 mL of very viscous, high specific gravity crude oil with ultrasonic pressure waves for 10 min, at a frequency and output power of 28 kHz and 300 W, respectively, drastically reduces the viscosity and specific gravity of the crude. The resultant low viscosity crude does not return to its original, heavy state in standard conditions, i.e. the change is permanent. The mechanism responsible for this observed change is sonochemistry, or more specifically, the sonochemical cracking of the long hydrocarbon chains, and the result is high quality, upgraded crude that is ready for pipeline transport. Although this process is ongoing (while the oil is being irradiated) and the results are permanent, they are continuously being combated by the naturally occurring catenation.

To avoid physically modifying the inside of holding tanks, or tank batteries in the field, thus rendering them inoperable for the setup time, sonolysis may be administered after storage. In particular, as described in more detail herein, arrays of ultrasonic transducers may be coupled to the outside walls of tanks in a geometrical configuration and/or arrays of ultrasonic transducers with long wave propagation devices, also generally referred to as horns, may be submerged inside the tank while attached to the tank roof. These transducers may induce cavitation within the hydrocarbons and hence physically and/or chemically alter their structure. The outside arrangement allows for field implementation without interrupting the operability of the tank, while the inside arrangement offers higher efficiency. Also, similar transducers may be employed downhole during or between sonofracturing treatments to affect changes in the hydrocarbons prior to and/or during recovery. As an added benefit, this distribution of ultrasonic arrays, whether aboveground or downhole, also depolymerizes the extra heavy crude, or sludge, that tends to build up on the bottom and along the sides of the tank with time, and breaks it into its lighter counterparts, effectively increasing the percentage of useful crude. Thus, in various embodiments, several mechanisms of heavy crude upgradation are disclosed, which may include one or more of the following: 1) lower the viscosity for ease of transport, 2) lower the specific gravity, 3) break the hydrocarbon chains, and/or 4) depolymerize the sludge, and 5) produce more useful, lighter hydrocarbons.

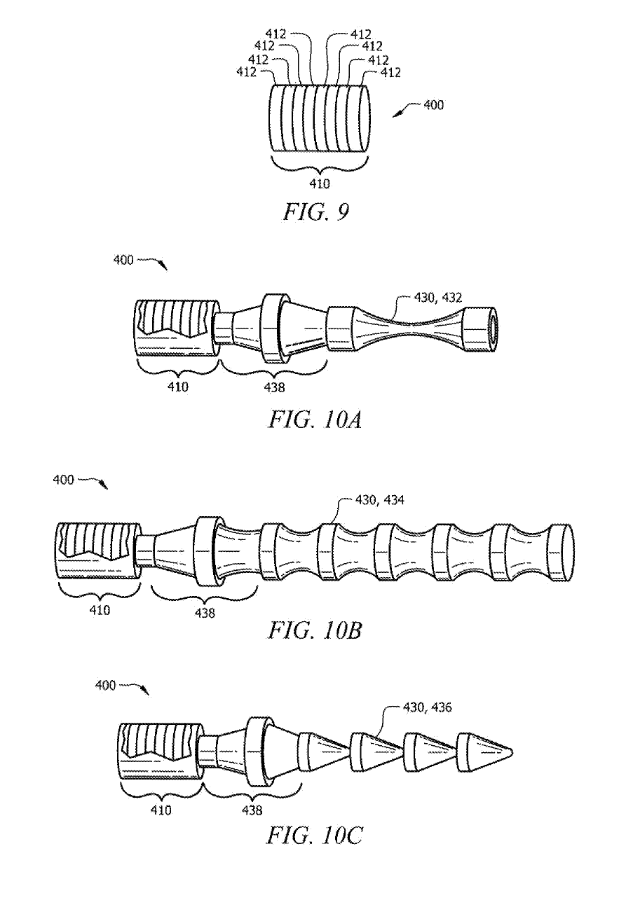

FIGS. 9-10C illustrate representative embodiments of a fluid stimulating apparatus 400 and parts thereof. It should be understood that the components of a fluid stimulating apparatus 400 and parts thereof shown in FIGS. 9-10C are for illustrative purposes only, and that any other suitable components or subcomponents may be used in conjunction with or in lieu of the components comprising a fluid stimulating apparatus 400 described herein.

Referring now to FIG. 9, fluid stimulating apparatus 400 may generally comprise similar components as sonofracing apparatus 100. For example, fluid stimulating apparatus 400 may comprise an acoustic assembly 410, a mass 420 (not shown), and a transmission member 430 (not shown), each having the same general characteristics as its respective counterpart 110, 120 and 130, respectively, in sonofracing apparatus 100. Similarly, acoustic assembly 410 may comprise one or more transducers 412, which in some embodiments, may be stacked.

Referring now to FIGS. 10A-10C, transmission member 430 may generally comprise an elongated ultrasonic wave propagation device. Wave propagation devices may amplify and focus pressure waves emitted from the transducers, and in various embodiments, may comprise a side profile that follows a mathematical formula and a radially symmetric cross section. Referring to FIG. 10A, transmission member 430 may comprise a half-wave or full-wave barbell ultrasonic wave propagation device 432. Full-wave barbell ultrasonic wave propagation devices generally exhibit high power density and high ultrasonic amplitude performance. In an embodiment, ultrasonic wave propagation device 432 may be substantially hollow. It is anticipated that such a design may provide even higher power densities and amplification. Referring now to FIG. 10B, transmission member 430 may comprise a cascaded, half-wave or full-wave barbell ultrasonic wave propagation device 434. A cascaded shape may increase amplification of pressure waves transmitted therethrough. Although amplification effects may drop off with distance from acoustic assembly 410, a cascaded shape may transmit amplified pressure waves to a greater volume of surrounding fluid than embodiments comprising a single barbell. Referring to FIG. 10C, transmission member 430 may comprise a cascaded, stepped ultrasonic wave propagation device 436. In various embodiments, wave propagation devices may comprise a cascaded mirror image structure (not shown) rather than a cascaded repeated structure (shown). In various embodiments, a tip subsection of wave propagation device may comprise a concave, a flat, or a convex distal surface. Alternatively, transmission member 430 may comprise a smaller wave propagation device similar to that described under sonofracing apparatus 100. In various embodiments, wave propagation devices 430, 432, 434, 436 may be coupled with acoustic assembly 410 by any suitable coupler 438. In an embodiment, coupler 438 may comprise a mounting flange. One having ordinary skill in the art will recognize a variety of suitable transmission member 430 shapes and constructions, and that the present disclosure should not be limited to the specific embodiments described herein.

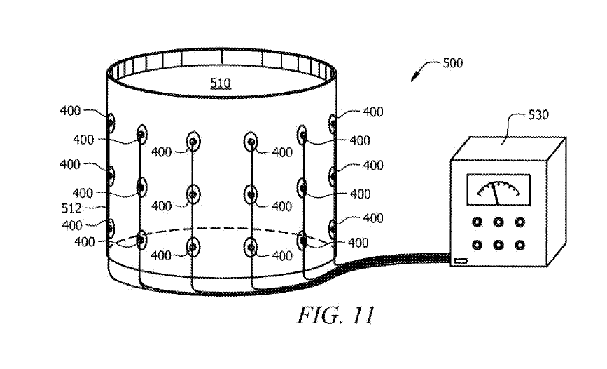

FIGS. 11-13C illustrate representative embodiments of a fluid stimulation system 500 and parts thereof. It should be understood that the components of a fluid stimulation system 500 and parts thereof shown in FIGS. 11-13C are for illustrative purposes only, and that any other suitable components or subcomponents may be used in conjunction with or in lieu of the components comprising a hydrocarbon stimulation system 500 described herein.

Fluid stimulation system 500 may generally comprise an array of two or more fluid stimulation apparatuses 400 configured to stimulate fluids, such as hydrocarbons and/or solvents in a storage tank 510. In various embodiments, fluid stimulation system 500 may further comprise power supply/controller 540 having similar characteristics as power supply/controllers 140 and 240.

Referring now to FIG. 11, fluid stimulation system 500 may comprise an array of two or more fluid stimulation apparatuses 400 coupled to an exterior surface of a tank 510 (“external stimulation array” generally). In various embodiments, each fluid stimulation apparatus 400 may comprise a small transmission member 430 similar to that described under sonofracing apparatus 100. The entirety of each fluid stimulation apparatus 400 may remain exterior to tank 510; that is, each fluid stimulation apparatus 400 does not physically penetrate into the tank 510, but rather resonates the fluid contained within the tank 510 from outside the tank 510. The external stimulation array may comprise any suitable number and arrangement of fluid stimulation apparatuses 400 coupled to an exterior surface of tank 510. In an embodiment, fluid stimulation apparatuses 400 are arranged in one or more rows around the circumference of tank 510. Rows may be placed at intervals, providing for selective operation of only those rows located at or below the level of hydrocarbons stored in tank 510. One having ordinary skill in the art will recognize this is only one of many suitable arrangements of fluid stimulation apparatuses 400, and that the present disclosure should not be limited to this specific illustrative embodiment. External placement of array of apparatuses 400 may necessitate strong resonation of tank 510 in order to stimulate hydrocarbons stored inside. In various embodiments, an array of numerous and powerful fluid stimulation apparatuses 400 may be used. However, because no holes or other modifications need be made to tank 510 in this external arrangement, retrofitting tank 510 in the field may be accomplished while tank 510 is in operation.

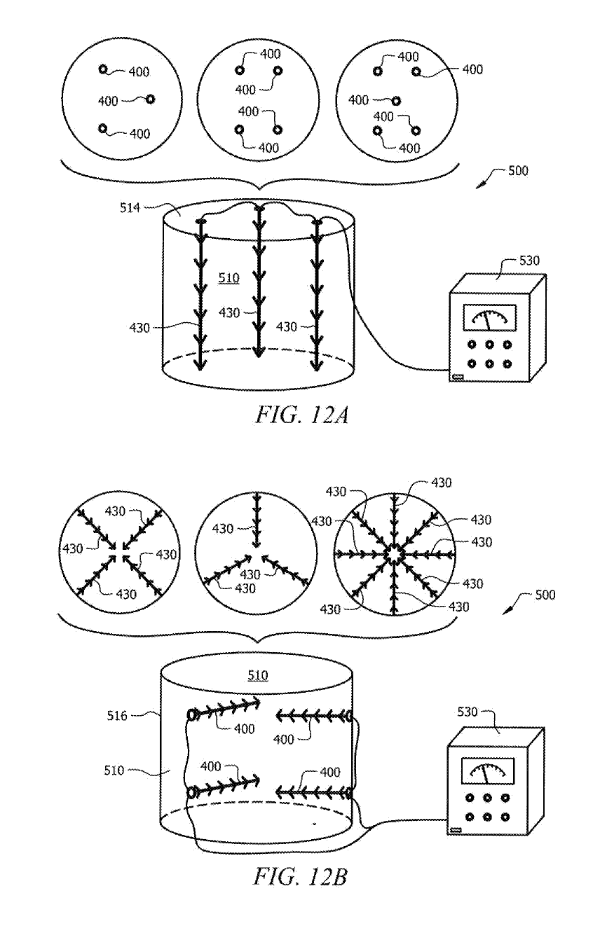

Referring now to FIGS. 12A and 12B, fluid stimulation system 500 may comprise an array of two or more fluid stimulation apparatuses 400 configured such that at least a portion of the apparatuses 400 penetrate the exterior surface or wall of the tank 510 and emit pressure waves into the hydrocarbons from within tank 510 (“penetrating stimulation array” generally). In various embodiments, each fluid stimulation apparatus 400 may comprise a transmission member 430 configured to extend through tank roof 514 or tank exterior surface 516 and into the interior of tank 510, such as ultrasonic wave propagation devices 432, 434 and 436. In various embodiments, acoustic assembly 410 of each fluid stimulation apparatus 400 may be located exterior to tank 510 (perhaps coupled to an outer surface) or embedded within any wall of tank 510, such as tank roof 514 or tank exterior surface 516, and transmission member 430 may extend through tank roof 514 or tank exterior surface 516, and into tank 510. The penetrating stimulation array may comprise any suitable number and arrangement of fluid stimulation apparatuses 400.

Referring to FIG. 12A, in an embodiment, fluid stimulation apparatuses 400 may be arranged in any suitable pattern through tank roof 514 with transmission members 430 extending down into tank 510. Such an application is appropriate for tanks 510 having fixed roofs. In an embodiment, transmission members 430 may extend to just above the bottom of tank 510. Roof-mounted penetrating stimulation arrays may be easier to mount than other arrangements, but may be functionally limited as only a fraction of transmission members 430 may be submerged in hydrocarbons at any given time, subjecting each to inhomogeneous heating (one of the energy losses associated with piezoelectric materials is through resistive heating).

Referring to FIG. 12B, in various embodiments, fluid stimulation apparatuses 400 may be arranged in any suitable pattern through tank exterior surface 516. Side-mounted penetrating stimulation arrays may be attached low on tank 510 so as to remain submerged in hydrocarbons stored therein, and may comprise transmission members 430 long enough to minimize free space at the center of tank 510. In an embodiment, transmission members 430 may extend radially within tank 510, and may be staggered circumferentially so as to provide substantially universal immersion. Such an application is appropriate for tanks 510 having fixed and floating roofs alike. In another embodiment, fluid stimulation apparatuses 400 may be arranged at intervals, providing for selective operation of only those rows located at or below the level of hydrocarbons stored in tank 510. One having ordinary skill in the art will recognize this is only one of many suitable arrangements of fluid stimulation apparatuses 400 in a penetrating stimulation array, and that the present disclosure should not be limited to this specific illustrative embodiment.

Side-mounted penetrating stimulation arrays may be automatically turned on as hydrocarbon levels rise in tank 510, but may be more difficult to install and may call for more apparatuses 400 than roof-mounted arrays. Unlike external stimulation arrays, penetrating stimulation arrays provide for direct contact between fluid stimulation apparatuses 400 and the hydrocarbons to be stimulated, thereby minimizing losses attributable to boundary interfaces and acoustic resistance.

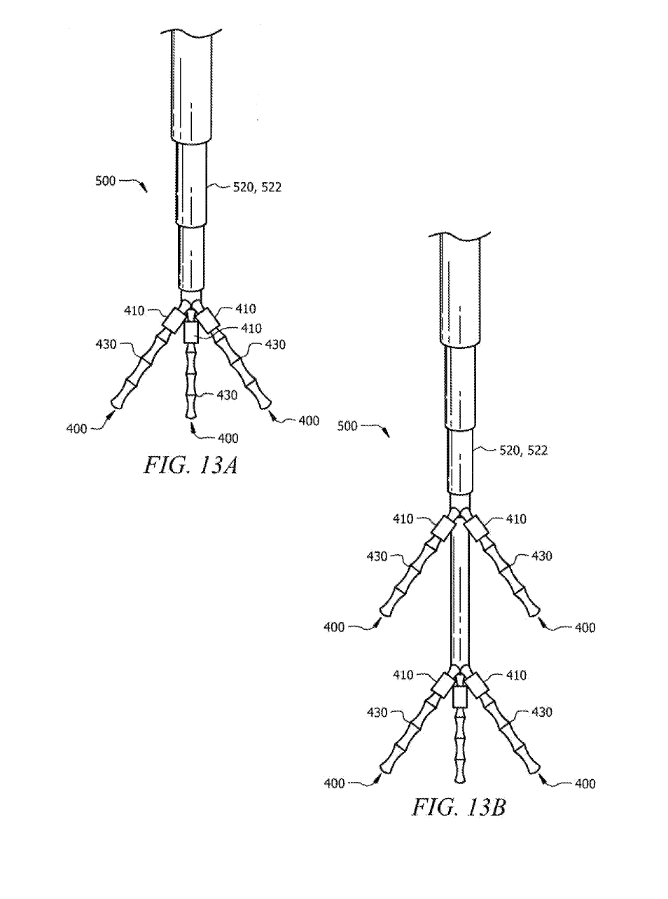

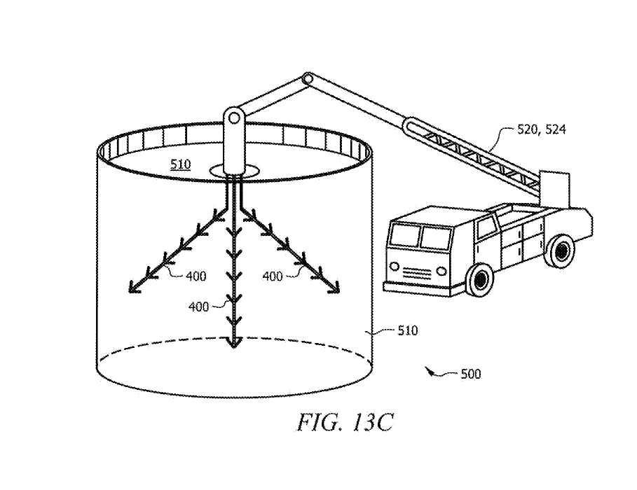

Referring now to FIGS. 13A and 13B, fluid stimulation system 500 may comprise an array of two or more fluid stimulation apparatuses 400 configured to emit pressure waves into the hydrocarbons from within tank 510. In various embodiments, the array may reside within tank 510, or alternatively, be inserted into tank 510 through an opening therein. In various embodiments, the array may comprise two or more fluid stimulation apparatuses 400 projecting outward from a central point (“central stimulation array” generally).

Referring to FIG. 13A, in various embodiment, each central stimulation array may comprise a “flowering” arrangement in which two or more fluid stimulation apparatuses 400 moveably spread out from a closed position, much like flower petals bloom from a closed bud. In an embodiment, two or three (or more) medium-length fluid stimulation apparatuses 400 each comprising a transmission member 430 may be configured to close tightly against a central axis, and mechanically spread out in operation. It should be recognized such movement may be effected by any number of couplings such as hinges and motors. In another embodiment (not shown), central stimulation array may comprise two or more fluid stimulation apparatuses 400 radially spreading outward in a fixed manner from a central point. Fluid stimulation apparatuses 400 may be coplanar (i.e. extend “straight out” from the central point) or may project in varying planes (for example, to form a cone or a shape similar to a Jack game-piece).

In various embodiments, fluid stimulation system 500 may further comprise delivery apparatus 520. Delivery apparatus 520 may comprise any suitable apparatus for positioning central stimulation array inside of tank 510. Still referring to FIG. 13A, delivery apparatus may comprise a telescoping arm 522. In an embodiment, a first end of telescoping arm 522 may be coupled (fixedly or rotatably) with tank roof 514 of tank 510 (not shown), and a central stimulation array (fixed or flowering) may be coupled to a second distal end of telescoping arm 522. Referring to FIG. 13B, in an embodiment, multiple central stimulation arrays may be coupled with telescoping arm 522. In operation, telescoping arm 522 may raise, lower, or rotate central stimulation array(s) within tank 510. Referring to FIG. 13C, delivery apparatus 520 may comprise a mobile platform 524, such as a ladder truck or other vehicle with a moveable arm. In operation, mobile platform 524 may travel from tank to tank and oilfield to oilfield as necessary to stimulate numerous tanks with one fluid stimulation system 500. As shown, mobile platform 524 may approach a tank 510 and insert the central stimulation array into the tank 510 via the telescoping arm 522 through an open top, an opening in tank roof 514 (not shown), or through a side-entry opening in tank exterior surface 516 (not shown). Some tanks do not require constant or even frequent stimulation; some need only be treated on an annual or biennial basis. If an oilfield produces consistently light hydrocarbons, stimulation treatments may be less frequent than if the oilfield produces heavy or extra heavy hydrocarbons. Thus, a single fluid stimulation system 500 comprising a mobile platform 524 may potentially service an entire oilfield in one embodiment, while it may be necessary to deploy multiple fluid stimulation systems 500 (one for each tank 510) in other embodiments.

Regardless of the method employed, accurate control of the triggering of fluid stimulation apparatuses 400 may be controlled and is application-dependent. Real-time analysis of the tank contents may inform the real-time control of fluid stimulation apparatuses 400. For example, because the viscosity of oil decreases with increasing temperature, thermistors can throttle back the output power of fluid stimulation apparatuses 400 as the sun heats the tank 510, as less power is needed. Another example is as the viscosity of the oil decreases (after ultrasonically irradiating it), subsequent applications of irradiation may be less powerful, taking advantage of the non-Newtonian flow characteristics of the hydrocarbons. While the oil in the tank is held in an emulsified state, it will not settle out and sludge will not accumulate at the bottom. Therefore, stimulating the oil while it accumulates in a storage tank significantly increases the utility of the tank.

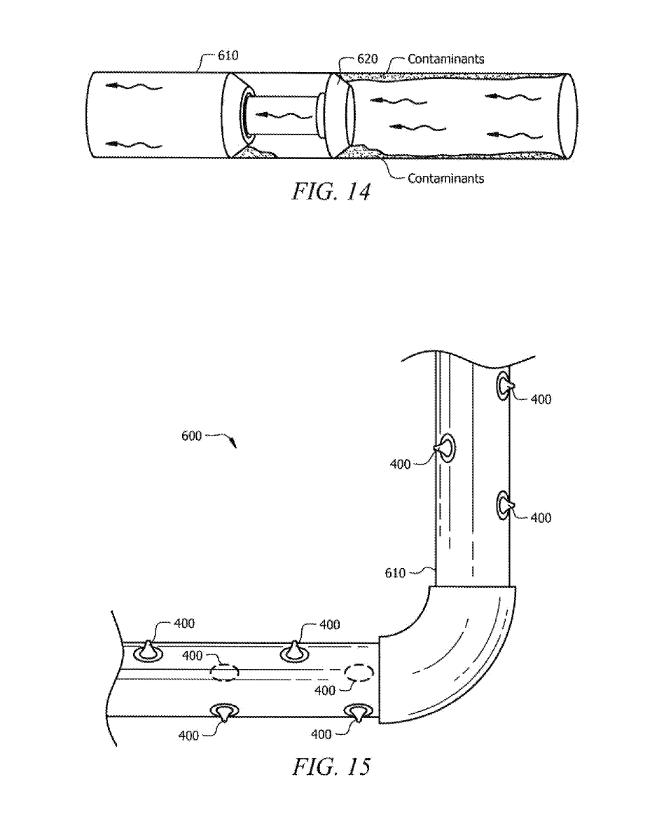

Fluid stimulation apparatuses 400 and systems 500 may also be employed in other applications. FIG. 14 depicts a typical pipeline 610 for transporting hydrocarbons. As hydrocarbons are transported through pipelines (flow is from right to left in FIG. 14), contaminants and sediment may get stuck along the sides and joints. The nature of the transported contents plays a significant role in the amount and type of contaminants found, i.e. liquids tend to carry more solid particles than do gases. Also, the longer a pipeline, the more severe the build-up. As a general rule, all pipelines require cleaning and/or replacement at some point in their lifetime (the Pipeline Integrity Bill in the United States requires pipelines to be inspected (and cleaned if necessary) every 5 years if transporting liquid and every 7 years if transporting natural gas).

Pipelines fail and an entire industry has been built around pipeline integrity. About 65% of oil pipeline failures result from corrosion and stress corrosion cracking (SCC), mostly from internal corrosion resulting from contaminants and trapped water, oxides and sulfides. Failing pipelines may account for some $300,000,000 in property damage, and failures may account for some 18 fatalities and 73 injuries per year. Additionally, pipeline inspection is still performed manually, and as such, is generally costly and slow.

Liquids are generally incompressible (compression requires the crushing of molecules, i.e. compressional forces must be stronger than the Pauli Exclusion Principle that dictates submolecular spacing). However, compression of gases is possible because it is simply a reduction in the empty space between molecules. In fast flowing pipelines, internal pressures can be so high that flowing gases are compressed so much that they resemble liquids, i.e. there is essentially no difference between liquids and gases.

Both liquids and gases resist shear flow, which is defined as a gradient in the speed of the flow perpendicular to the direction of the flow. In other words, they are viscous. However, the velocity of a fluid in a pipe is not constant. Specifically, velocity follows a radial distribution: the closer to the center of the pipe, the faster the flow. Frictional forces resist the flow and slow the movement of particles in contact with the pipe wall. The frictional forces of those slower particles subsequently resist the flow and slow the movement of particles in contact with them, but to a slighter degree. As impeded fluid interacts with the wall, solid contaminants are left behind in a process known as adsorption (the adhesion of atoms, ions, etc. from a gas or liquid to a solid surface). As an accumulation layer builds up along the wall of a pipeline, the conduit is further restricted and flow is further resisted. Coalescence also occurs at the surface because like contaminants are often attracted to like contaminants, usually via van der Waals forces. Finally, surface corrosion may occur as the adsorbed contaminants chemically attack the pipeline wall.

The more sediment that accumulates on the inner wall, the smaller the effective diameter of the pipeline and the more friction and compression the fluids encounter. Consequently, either the flowing fluids become more compressed (which is limited by molecular forces) or their velocity is reduced. For completeness, the inherent compressibility of gases makes them less susceptible (than liquids) to compressional drag.

Given the detrimental effects of the natural build-up of contaminants and sediments along the pipeline wall, pipeline inspection and cleaning are occasionally required. Manual cleaning methods often use a cylindrical device known as a pig 620 that essentially behaves like a handheld pipe cleaner: it fills the inner diameter of the pipeline, and as it is pushed through the pipeline by flow behind the pig 620 (from left to right in FIG. 14), the pig 620 scrapes the inner wall of the pipeline, thereby removing built-up debris and pushing it along toward a retrieval port. Most pigs have a center-through design so that oil and gas can flow through them and so that their presence does not preclude the functionality of the pipeline. Intelligent, or smart pigs are equipped with additional inspection tools and can collect data while they clean. Inspections they commonly perform include surface pitting and corrosion maps, crack and weld defect maps, ultrasonic leak tests, and roundness measurements.

Similar to retrofitting the outsides of storage tanks to decrease the viscosity of the stored hydrocarbons and reduce accumulation in the tanks, pipelines can be outfitted to stimulate the oil as it is being transported.

FIGS. 15 and 16 illustrate representative embodiments of a fluid stimulation system 600 and parts thereof. It should be understood that the components of a fluid stimulation system 600 and parts thereof shown in FIGS. 15 and 16 are for illustrative purposes only, and that any other suitable components or subcomponents may be used in conjunction with or in lieu of the components comprising a fluid stimulation system 600 described herein.

Referring now to FIG. 15, in various embodiments, fluid stimulation system 600 may generally comprise an array of two or more fluid stimulation apparatuses 400 configured to stimulate hydrocarbons in a pipeline 610. The array of fluid stimulation system 600 may comprise any suitable number and arrangement of fluid stimulation apparatuses 400. Depending on the age of pipeline 610, its environment, and the contents being transported, the array may comprise fluid stimulation apparatuses 400 coupled to the pipeline 610 at suitable intervals. In various embodiments, an apparatus 400 may be coupled to the pipeline 610 every 10-100 feet. In various embodiments, the array of fluid stimulation apparatuses 400 may comprise small transmission members 430 and couple with an exterior surface of pipeline 610, much like the external stimulation array of system 500. In various other embodiments, apparatuses 400 may comprise elongated transmission members 430 (such as wave propagation devices 432, 434, and 436) that may be inserted into pipeline 610, much like the penetrating stimulation array of system 500. In an embodiment, acoustic assembly 410 of each apparatus 400 may be located exterior to pipeline 610 (perhaps coupled to outer surface thereof), and transmission member 430 may penetrate into pipeline 610. In an embodiment, these transmission members 430 may be a few inches in length. Of course, any suitable embodiment of fluid stimulation apparatus 400 may be employed in the array of fluid stimulation system 600. Either way, as pressure waves are emitted into the pipeline by the apparatuses 400, the accumulated contaminants are vibrated off the inside surface of pipeline 610, and subsequent pulses may be of lower power and/or shorter pulse width ratios (ratio of time on vs. time off in one period).

Referring now to FIG. 16, most pipeline failures are from corrosion or SCC. The cracks, however, do not form as cracks but rather are nucleated from a singular point (“nucleation site” 612). The moment a nucleation site 612 develops, gases begin to leak out (even if transporting volatile liquids). When a leak occurs at a nucleation site 612 in pipeline 610, the released gases may be ejected at very high speeds and may have a detectable ultrasonic footprint. Fluid stimulation apparatuses 400 of fluid stimulation system 600 that are used to stimulate the transported hydrocarbons may be converted to record the ultrasonic footprints of leaks. In various embodiments, apparatuses 400 may already be tuned to the appropriate frequency spectrum; they only need to be reconfigured from emitting pressure waves to detecting vibrations associated with a leak (i.e., reconfigured to operate as an input into an oscilloscope). In an embodiment, a power supply/controller (not shown) may be operable to reconfigure apparatuses in response to user input or computer logic. By detecting a potential leak at several locations (with several apparatuses 400), a map of the footprint intensity can be made. Just as seismometers are employed to populate a χ² (Chi squared) map to locate the epicenter of a seismic event, the array of apparatuses 400 may be used to find a nucleation site 612 of a leak before it becomes a crack. In other words, in various embodiments, once pipelines 610 are outfitted with fluid stimulation system 600, they can be inspected automatically. A duty cycle can be set such that, for instance, pipeline 610 may be vibrated for 10 seconds every minute for just under 24 hours straight, at which point the array of apparatuses 400 may be set to read and a full inspection may take place. The results of this inspection can then be compared to previous results and judgments can be made as to whether or not the pipeline 610 has experienced damage. Alternatively, coarse measurements can be taken over the entire pipeline 610 every hour or every few hours and fine measurements can be taken only when and where leak footprints occur.

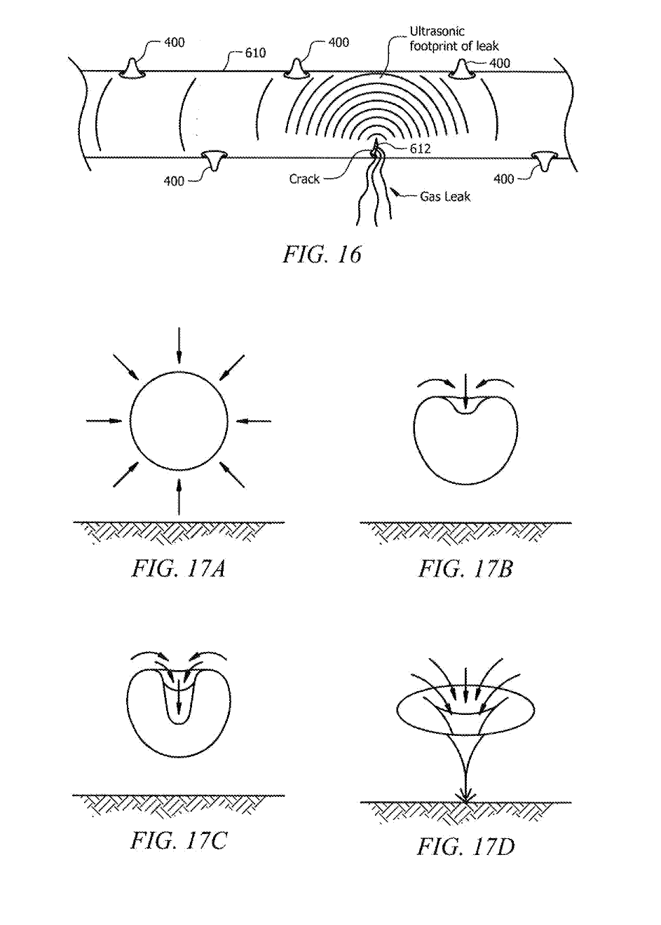

In another aspect, acoustic cavitation resulting from pressure waves propagated through a fluid may produce microjets that impinge a proximate solid surface to emulsify a viscous hydrocarbon residue adhered to the proximate solid surface. FIGS. 17A-17D illustrate how acoustic cavitation may produce microjets resulting from the formation and collapse of microscopic bubbles near a large solid surface. FIG. 17A depicts a microscopic bubble at its resonant size. FIG. 17B depicts the bubble as it begins to collapse and distort. FIG. 17C depicts the initial formation of a microjet in the center of the collapsing bubble. FIG. 17D depicts the resulting microjet impinging a nearby solid surface. In various embodiments, emulsifying the viscous hydrocarbon residue may comprise removing at least a portion of the residue from the proximate solid surface to blend with the hydrocarbon fluid medium.

Acoustic cavitation is the formation, expansion, and implosive collapse of microscopic bubbles in a solution that is ultrasonically irradiated. In an isotropic solution, these bubbles are perfectly spherical, i.e. the expansion and collapse both have only radial components. However, if a cavity is created near a large solid surface (several times larger than the cavity size), the collapse of the cavity that is normally spherical becomes nonspherical and asymmetric. This asymmetry manifests as a deformation during collapse and drives a high-speed (˜100 m/s) jet of liquid into the solid surface. The local temperatures, pressures, and heating rates associated with cavity collapse are extreme (˜5000 K, ˜2000 atm, and ˜105 K/s, respectively); the microjets are at these very conditions and are of sufficient power to induce substantial surface damage. The microjets impact and erode the surface, ejecting solid material from and greatly heating the virgin subsurface.

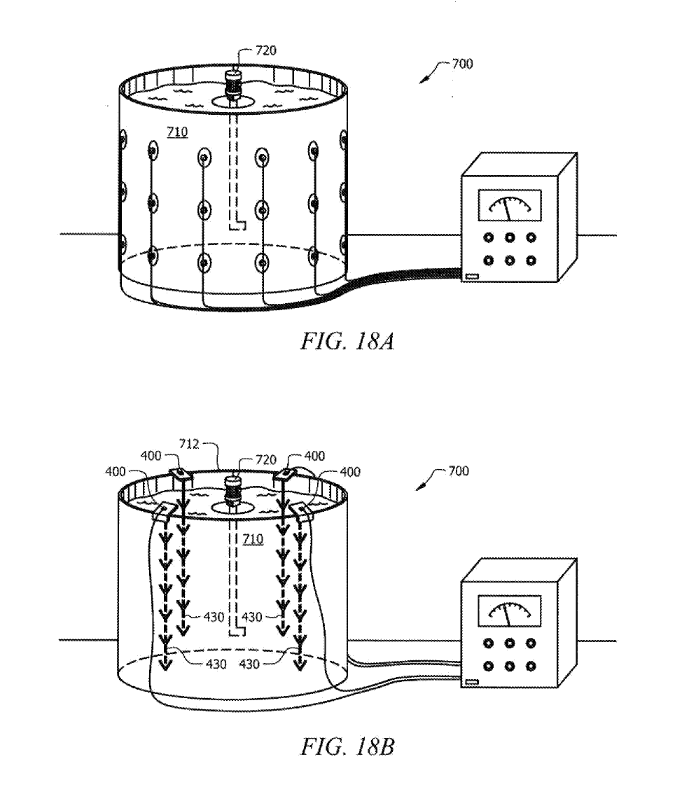

FIGS. 18A and 18B illustrate representative embodiments of an ultrasonic cleaning system 700 and parts thereof. It should be understood that the components of a ultrasonic cleaning system 700 and parts thereof shown in FIGS. 18A and 18B are for illustrative purposes only, and that any other suitable components or subcomponents may be used in conjunction with or in lieu of the components comprising a ultrasonic cleaning system 700 described herein.

Referring now to FIG. 18A, in various embodiments, ultrasonic cleaning system 700 may comprise an array of two or more fluid stimulation apparatuses 400 coupled to an exterior surface of tank 710 (“external cleaning array” generally). In various embodiments, each apparatus 400 and array thereof may be configured similar to those described in the context of external stimulation array of fluid stimulation system 500. Referring now to FIG. 18B, in various embodiments, ultrasonic cleaning system 700 may comprise an array of two or more fluid stimulation apparatuses 400 configured to couple with flanges (or other suitable hardware) and hung from a lip 712 of tank 710 (“internal cleaning array” generally). In various embodiments, each fluid stimulation apparatus 400 and array thereof may be configured similar to those described in the context of penetrating stimulation array of fluid stimulation system 500. It will be understood that internal cleaning arrays need not penetrate a tank roof 514 or tank external surface 516 as described in the context of fluid stimulation system 500 employed on tank 510; rather, the general crux of such embodiments is at least partial introduction of transmission members 430 within tank 710. In various embodiments (not shown), internal cleaning array may comprise elements and arrangement similar to those described in the context of central stimulation array of fluid stimulation system 500. In various embodiments, ultrasonic cleaning system 700 may further comprise power supply/controller having similar characteristics as power supply/controllers previously described.

In operation, ultrasonic cleaning system 700 may be used to ultrasonically clean service parts, downhole pumps and other oilfield tools (collectively, “parts 720”) while in the oilfield. In various embodiments, large onsite tanks 710 may be outfitted with system 700, and parts 720 may be submerged and cleaned therein. The number and power of apparatuses 400 may depend on the size of tank 710, but if they are configured in an external cleaning array, acoustic impedance losses at the surface need to be considered. Incidentally, hydraulic fracturing wells already have waste-water tanks that may be retrofitted and used as cleaning baths, drastically reducing the setup costs.

Ultrasonic cleaning is a process of irradiating a solvent, such as water or other suitable solvent, in such a way as to take advantage of this microjet erosion of a solid surface —such as a solid surface on a service part, downhole pump or other oilfield tool. The high-speed jets attack and forcefully remove hydrocarbon residue and other surface contaminants, much like a power-washer. In an embodiment, substantially removing the hydrocarbon residue may comprise emulsifying the hydrocarbon residue. As more residue and/or contaminants are removed, they begin to form an abrasive slurry that aids in the cleaning process. The cavities also penetrate fissures and recesses, effectively cleaning them out as well.

Cleaning oilfield parts 720 currently requires chemical etchants and baths and leaves a significant environmental impact as both the waste-water and the etchants have to be properly disposed. Ultrasonically cleaning those same parts 720 may call for only water or another environmentally friendly solvent. Moreover, if a cleaning process requires multiple submersions (the caked and dried oil is too thick to clean quickly), the initial stages can use the waste-water from tank cleaning or other oilfield processes.

Because oilfield tools and parts 720 do not require constant cleaning, the ultrasonic baths need only be used on occasion. As needed, the contaminated tools or parts 720 are simply lowered into the bath and ultrasonic cleaning system 700 may be set to emit pressure waves continuously for a specified amount of time, depending on the size of the tank 710 and the difficulty of the cleaning to be accomplished. When the cleaning is complete, the top of the bath may be skimmed, any recovered hydrocarbons returned to the tank owner, and the tank 710 is ready for the next cleaning cycle.

In operation, ultrasonic cleaning system 700 may be further used to ultrasonically clean tanks, pipelines, or other hydrocarbon storage/transport vessels while in the oilfield. Ultrasonic irradiation of oil stimulates it and consequently makes it easier to flow. In-tank stimulation maintains the recovered oil in an emulsified state so that sludge accumulation is inhibited and the oil remains ready for transport for further processing. It logically follows that in-tank oil stimulation is in some ways synonymous with tank cleanup. If sludge accumulation is inhibited, tank cleanup (whether manual or automatic) is minimized and as such, cost savings are realized by the operator/owner of the tank battery.

Another benefit of ultrasonic cleaning over semi-automatic or automatic cleaning is instrument maintenance. Mixers, nozzles, and skimmers all have moving parts and therefore deteriorate in time. Transducers have no moving parts and their only shortcoming is overheating, which can easily be remedied by using temperature sensors to influence their usage.

The sequencing of triggering the array of apparatuses 400 in system 700 may be controlled and will be custom configured for each tank configuration and altered as needed. Because apparatuses 400 tend to generate heat, temperature readings must be taken on a periodic basis and fed into a feedback loop for real-time adjustments of the timing sequence. This temperature dependence is both beneficial and detrimental to the overall performance. Although it can help prevent overheating, it can force apparatuses 400 to operate at insufficient powers or intervals to maintain complete emulsification. Therefore, it is possible that occasional traditional cleaning methods must still be employed, but on a much longer time scale.

Once a solvent/hydrocarbon mixture is treated with ultrasonic irradiation, it will be emulsified and will stay that way for weeks. However, this emulsification, which is desirable at the tank, is undesirable to the tank owner. The tank owner wants the hydrocarbons with as little water/solvent content as possible. Simply running the mixture through a centrifuge separates it into stratified layers of water/solvent and hydrocarbons.

It will be further appreciated that embodiments of sonofracing systems 150 and 250 may be modified to apply hydrocarbon stimulating concepts downhole to stimulate hydrocarbons residing in rock formations. Downhole stimulation may be configured to alter the physical/chemical properties of downhole hydrocarbons to enhance hydrocarbon recovery. For example, hydrocarbons residing in a rock formation may be ultrasonically irradiated to reduce the viscosity of those hydrocarbons, making it easier to extract them through natural and/or man-made (drilled, fracked, etc) conduits in the rock formation.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A field-deployable system for stimulating an organic compound within a hydrocarbon, comprising:
an array of two or more acoustic transducers, each of the acoustic transducers comprising a tuning mass and a transmission member; and
a structure containing the hydrocarbon;
wherein the transmission members of the acoustic transducers are coupled to an exterior wall of the structure such that the acoustic transducers are isolated from fluid contact with the hydrocarbon;
wherein the acoustic transducers are arranged to propagate pressure waves through the material forming the exterior wall of the structure and into the hydrocarbon;
wherein the pressure waves induce acoustic cavitation in the hydrocarbon; and
wherein the acoustic cavitation results in a chemical or physical property change in the organic compound within the hydrocarbon.

2-7. (canceled)

8. The field-deployable system of claim 1, wherein the structure is selected from the group consisting of: a storage tank, a pipeline and a well casing.

9. The field-deployable system of claim 1, further comprising a power supply comprising at least one electrochemical capacitor.

10. The field-deployable system of claim 9, further comprising a controller configured to control: the characteristics of the pressure waves emitted by each of the two or more acoustic transducers, the trigger sequence of the two or more acoustic transducers, or both.

11. A method of stimulating an organic compound within a hydrocarbon comprising:
propagating pressure waves through the hydrocarbon;
wherein the pressure waves have an ultrasonic frequency and an amplitude sufficient to induce acoustic cavitation in the hydrocarbon; and
wherein the acoustic cavitation results in a change in at least one chemical or physical property of the organic compound within the hydrocarbon.

12. (canceled)

13. The method of claim 11, wherein the acoustic cavitation results in at least one of the following chemical or physical property changes in the organic compound within the hydrocarbon: lower fluid viscosity, lower specific gravity, shortened hydrocarbon chain length, or depolymerization of at least a portion of the organic compound within the hydrocarbon.

14. The method of claim 11, wherein the acoustic cavitation creates a microjet that impinges a proximate solid surface to emulsify a viscous hydrocarbon residue adhered to the proximate solid surface.

15. The method of claim 14, wherein emulsifying the viscous hydrocarbon residue comprises removing at least a portion of the residue from the proximate solid surface to blend with the hydrocarbon.

16. The method of claim 11, wherein propagating pressure waves through the hydrocarbon is selected from the group consisting of: a plurality of acoustic transducers propagating pressure waves directionally inward toward a target zone; a plurality of acoustic transducers propagating pressure waves directionally outward from one another; and a plurality of acoustic transducers propagating pressure waves in generally the same direction.

17-29. (canceled)

30. The field deployable system of claim 1,
wherein the hydrocarbon is substantially stationary within the structure.

31. The field deployable system of claim 1,
wherein the hydrocarbon is flowing within the structure.

32-33. (canceled)

34. The field deployable system of claim 1, wherein the array is arranged such that the propagated pressure waves constructively interfere in a target zone in the hydrocarbon to induce acoustic cavitation in the target zone in the hydrocarbon.

35. The method of claim 1, further comprising phasing the pressure waves to constructively interfere in a target zone in the hydrocarbon to induce acoustic cavitation in the target zone in the hydrocarbon.

36. The method of claim 11, wherein the hydrocarbon is flowing.

37. The method of claim 11, wherein the hydrocarbon is substantially stationary.

38. A method of stimulating an organic compound within a hydrocarbon comprising:
propagating pressure waves through the hydrocarbon to produce constructive interference in a target zone in the hydrocarbon;
wherein the pressure waves have an ultrasonic frequency and an amplitude sufficient to induce acoustic cavitation in the target zone in the hydrocarbon; and
wherein the acoustic cavitation results in a change in at least one chemical or physical property of the organic compound within the hydrocarbon.

39. The method of claim 38, further comprising coupling an array of acoustic transducers to an exterior wall of a structure containing the hydrocarbon such that the exterior wall of the structure isolates the array from fluid contact with the hydrocarbon.

40. The method of claim 39, further comprising propagating the pressure waves through the material forming the exterior wall of the structure and into the hydrocarbon.

41. The method of claim 38, wherein the hydrocarbon is substantially stationary.

42. The method of claim 38, wherein the hydrocarbon is flowing.

43. The method of claim 38, wherein the acoustic cavitation results in a lower fluid viscosity of the organic compound within the hydrocarbon.

44. The method of claim 38, wherein the acoustic cavitation results in a lower specific gravity of the organic compound within the hydrocarbon.

45. The method of claim 38, wherein the acoustic cavitation results in a shortened hydrocarbon chain length of the organic compound within the hydrocarbon.

46. The method of claim 38, wherein the acoustic cavitation results in depolymerization of at least a portion of the organic compound within the hydrocarbon.
